(19) United States
(12) Patent Application Publication
(10) Pub. No.: US 2012/0021186 A1
(43) Pub. Date: Jan. 26, 2012

(54) SEAM STRUCTURE AND METHOD FOR MAKING A SEAM

(76) Inventor: Uwe Schneider, Cincinnati, OH (US)

(21) Appl. No.: 12/795,021

(22) Filed: Jun. 7, 2010

(51) Int. Cl. B32B 37/06; B32B 37/14; B32B 3/00; B32B 37/04

(52) U.S. Cl. 428/189; 156/60

(57) ABSTRACT

A seam comprising two or more porous, at least partially meltable materials, having substantially the same melting temperature. A process for making the seam using heated fluid may be used to join all of the materials at the seam, or to join only selected layers of a laminate in a seam.

### FIELD OF THE INVENTION

The disclosure relates to a seam joining two or more porous, at least partially meltable materials, and a method for making a seam joining two or more porous, at least partially meltable materials. The seam may be used, for example, as the side seam in a pull-on disposable absorbent article.

### BACKGROUND OF THE INVENTION

Disposable absorbent articles, in particular, disposable diapers, are designed to be worn by people experiencing incontinence, including infants and invalids. Such diapers are worn about the lower torso of the wearer and are intended to absorb and contain urine and other bodily discharges, thus preventing the soiling, wetting, or similar contamination of articles that may come into contact with a diaper during use (e.g., clothing, bedding, other people, etc.). Disposable diapers are available in the form of pull-on diapers, also referred to as training pants, having fixed sides. The fixed sides may be manufactured by joining side panels of the front portion of the diaper to side panels of the rear portion of the diaper. For joining purposes, the contacting surfaces of the side panels may be at least partially melted. Melting the outer surfaces may be undesirable, as the melted material sometimes may be associated with hard, raspy protuberances that may cause, or be perceived to cause, skin irritation or discomfort.

The fixed sides of a pull-on diaper may be torn to remove the product after use (e.g., when the article is soiled). Thus, it may be desirable to provide a seam that has relatively strong shear strength and relatively weak peel strength, such that the side can be easily peeled opened along the seam between the waist edge and the leg opening. If the shear strength is insufficient, the seam may fail due to wearer movement or exudate loading before the wearer or caregiver intends to remove the diaper. However, strong bonds may have undesirable aesthetic aspects, and may have a rough feel. Further, if the peel strength is excessive, it may be difficult to remove a soiled pull-on diaper without pulling the soiled pull-on diaper down the entire length of the wearer's legs. If the peel strength is inconsistent along the length of the fixed sides, the seams may open via different failure modes. For example, part of the seam may fail at specific bond sites, allowing the seam to open. This may be the desired mode of failure. However, it is also possible for the fixed sides to be torn through the materials alongside the seam, or, if the materials alongside the seam include one or more laminates, to delaminate one of the laminates. This may be an undesired mode of failure, as it may convey the impression that the fixed sides are not intended to be opened after use.

There remains a need for a seam which provides a relatively high shear strength, and a relatively low peel strength. There remains a need for a seam which can provide these competing properties without creating a raspy, rough, or harsh-feeling protuberance on an outer surface of the seam.

### SUMMARY OF THE INVENTION

A method of joining two or more webs may comprise providing a first web and a second web, each of the first and second webs being porous and having a melting temperature and an outer surface, the melting temperatures of first and second webs being substantially the same; placing at least a portion of the first web adjacent at least a portion of the second web to form an overlap area; sufficiently heating a fluid to enable at least a partial melting of the first and second webs; directing a jet of the heated fluid toward at least one of the outer surface of the first web and the outer surface of the second web; and allowing the heated fluid to penetrate the first and second webs such that at least a portion of each of the first and second webs is melted in the overlap area. The edges of the first and second webs may be joined to form an overlap seam or a butt seam. The fluid may be ambient air.

The method may further comprise compressing the first and second webs in at least a portion of the overlap area. The first and second webs may be non-wovens. The method may further comprise bonding a third web to at least one of the first web and the second web at a location inboard of a seam between the first web and the second web. The third web, if present, may have a melting temperature which is not substantially the same as the melting temperatures of the first and second webs. The melting temperatures of the first and second webs may be the same.

The method may further comprise providing a fourth web, the fourth web being porous and having a melting temperature and an outer surface, the melting temperature of the fourth web being substantially the same as the melting temperatures of the first and second webs; placing a portion of the fourth web adjacent a portion of the first web or a portion of the second web in the overlap area; sufficiently heating a fluid to enable at least a partial melting of the first, second, and fourth webs; and allowing the heated fluid to penetrate the first, second, and fourth webs such that at least a portion of each of the first, second, and fourth webs is melted in the overlap area. The fourth web may overlap the first web or the second web or both the first web and the second web.

A seam may be produced according to the method, and an absorbent article may comprise such a seam. A seam in an absorbent article may have a ratio of shear load to peel load greater than about 8:1, or greater than about 30:1.

A method of selectively seaming only selected layers of a laminate may comprise providing a first web and a second web, each of the first and second webs being porous and having a melting temperature and an outer surface, the melting temperatures of first and second webs being substantially the same; providing a fifth web; placing one edge of the first web adjacent one edge of the second web; placing one edge of the second web adjacent one edge of the fifth web, such that the fifth web is not adjacent to the first web; sufficiently heating a fluid to enable at least a partial melting of the first and second webs; directing a jet of the heated fluid toward at least one of the outer surface of the first web and the outer surface of the second web; and allowing the heated fluid to penetrate only the first and second webs, such that at least a portion of each of the first and second webs is melted. The method may further comprise compressing the melted portions of the first and second webs together. The first and second webs may be compressed together with the fifth web. The method may further comprise providing a reinforcement material, placing a portion of the reinforcement material adjacent the first web or the second web, and allowing the heated fluid to penetrate the reinforcement material.

### BRIEF DESCRIPTION OF THE DRAWINGS

FIG. 1A is a schematic side view of an exemplary overlap seam.

FIG. 1B is a schematic side view of an exemplary butt-type seam.

FIG. 2 is a micrograph of a seam according to the present disclosure.

FIG. 3 is a micrograph of a seam not formed according to the present disclosure.

FIG. 4 is a simplified schematic drawing of a rotary apparatus useful for joining two or more webs.

FIG. 5 is a simplified and partially sectioned view of an exemplary cylinder from the rotary apparatus of FIG. 4.

FIG. 6 is a perspective view of a stationary apparatus useful for joining two or more webs.

FIG. 7A is a view of an exemplary pull-on diaper, configured as it would be worn.

FIG. 7B is a plan view of an exemplary pull-on diaper without side seams, with the wearer-facing surface up.

FIG. 7C is a perspective view of an exemplary side seam that has been partially separated by a peel force.

FIG. 8 is a schematic top plan view of the waist of a pull-on diaper.

FIG. 9 is a schematic top plan view of a reinforced seam.

FIG. 10 is a schematic top plan view of a reinforced seam.

FIG. 11 is a schematic top plan view of a reinforced seam.

### DETAILED DESCRIPTION OF THE INVENTION

As used herein, the term “joining” describes a configuration whereby a first element is directly secured to another element by affixing the first element directly to the other element.

As used herein, the term “web” refers to a layer of material(s). The term “layer” does not necessarily limit the web to a single stratum of material, and may encompass laminates of like or unlike materials which are joined or unjoined.

As used herein, the term “pull-on diaper” refers to a garment that is generally worn by infants and sufferers of incontinence, which is pulled on like pants. It should be understood, however, that the present disclosure is also applicable to other absorbent articles, such as taped diapers, incontinence briefs, feminine hygiene garments, and the like, including absorbent articles intended for use by infants, children, and adults.

As used herein, the term “inboard” refers to a first element or material which is nearer the lateral or longitudinal centerline of an article relative to a second element or material, the second element or material being “outboard” of the first.

As used herein, the term “porous” refers to a material having an air permeability of at least 30 cm³/cm²/sec when tested according to the standard test method for Permeability to Air; Cloth; Calibrated Orifice Method, as described in Method 5450 of Federal Test Method Standard No. 191A. Additional test details are described in the Test Methods section below.

As used herein, the term “at least partially melted” refers to materials at least a portion of which have reached at least a softening point temperature, but have not reached a melt point temperature. “Melted” also refers, in its ordinary sense, to materials which have exceeded their melt point temperatures over at least a portion of the material.

In some aspects, the present disclosure relates to seams, methods for making seams, articles comprising a seam, and methods for making articles comprising a seam. As described in greater detail below, a seam may be formed between two webs, each web comprising one or more meltable components. The webs to be seamed may be positioned adjacent one another, and heated to at least a softening temperature, or a melting temperature, to at least partially melt one or both of the webs. The webs may be compressed after heating. In some embodiments described herein, a seam may be produced which requires a strong load to disrupt the seam in a first direction, and a relatively weak load to disrupt the seam in a second direction. Such directional strength may be useful for providing a seam which is durable when subjected to a first force or set of forces during use, and frangible when subjected to a second force or set of forces during or after use. The description which follows describes generally a seam and a method for making a seam, specific embodiments, and some possible advantages associated with one or more specific embodiments. While various embodiments are separately described and illustrated, it is to be appreciated that various aspects of the different embodiments can be combined to produce yet further embodiments, which may not be described explicitly for the purpose of brevity.

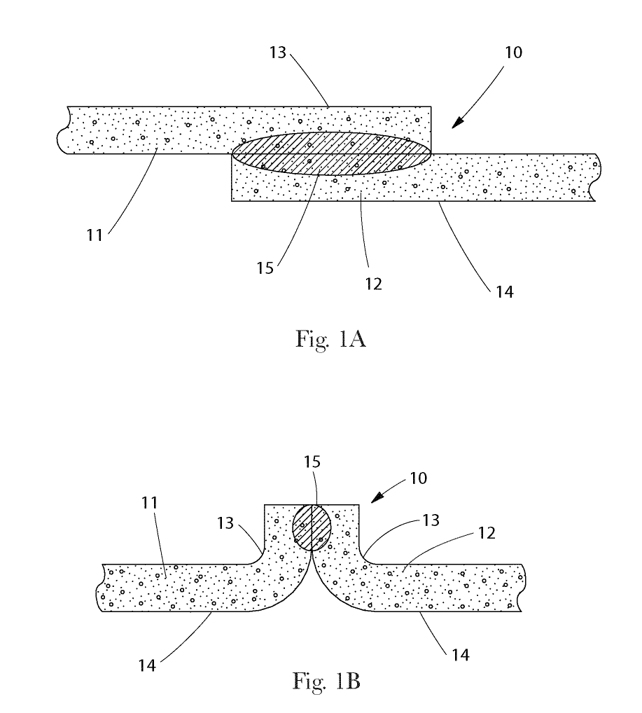

A schematic, fragmentary side elevational view of two webs to be joined is shown in FIGS. 1A and 1B. In particular, FIGS. 1A and 1B show at least two porous webs 11, 12 that have been arranged in an adjacent manner to form a seam 10. The seam 10 comprises outer surfaces 13, 14 and an area of overlap 15 between the webs 11, 12. FIG. 1A shows a configuration herein referred to as an overlap seam, wherein two or more materials are joined along adjacent, overlapping surfaces. FIG. 1B shows a configuration herein referred to as a butt seam, wherein two or more materials are joined at or near their edges, and the materials are folded back, away from the seam.

At least one of the webs may comprise sufficient meltable material that the web is susceptible to being thermally joined to another web. Webs 11, 12 may be porous—air permeable, fluid permeable or vapor permeable—and web 11, web 12, or both may comprise meltable components. Webs 11, 12 may be woven or non-woven, and may comprise fibers or polymeric binders, natural fibers such as cellulose—wood pulp, cotton, jute, hemp; synthetic fibers such as rayon, polyester, polyolefin, acrylic, polyamide, aramid, polytetrafluroethylene metal, polyimide; or binders such as bicomponent fibers, copolymer polyester, polyvinyl chloride, polyvinyl acetate/chloride copolymer, copolymer polyamide. The webs may comprise blends of materials wherein some of the constituent materials are not meltable. Webs 11, 12 may be of the same or different materials. Webs 11, 12 each have a melting temperature, and the melting temperature of webs 11, 12 may be substantially the same. The melting temperatures are substantially the same if they are within 30° C. of each other. The melting temperatures of webs 11, 12 may be within 10° C. of each other, or within 5° C. of each other. In some embodiments, the melting temperatures of webs 11, 12 are the same. As the difference between the melting temperatures of webs 11, 12 decreases, the ability to control the seam increases.

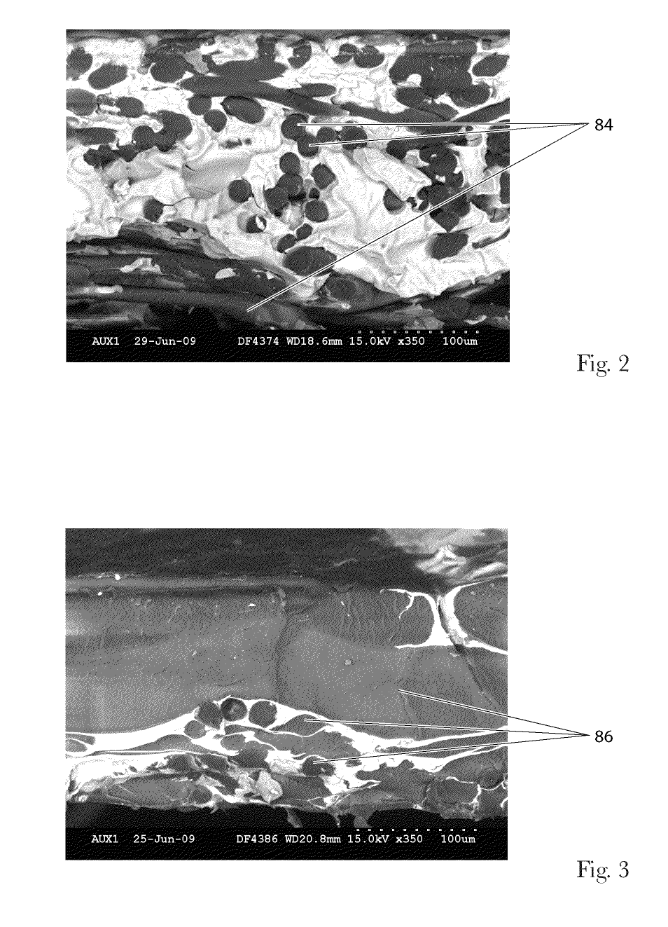

The seaming process doses and disperses thermal energy in and around the area where a bond will be formed. The lower the thermal energy delivered to form the bond, the less likely the process is to damage nearby materials, or to impact layers adjacent the intended bond site. Hot air, for example, may be dispersed through porous layers, or, where the melting temperature of webs 11, 12 is not the same, hot air may be used to form a hole through the outer layer, allowing penetration of the hot air to the inner web or webs. Where webs 11, 12 are each porous and webs 11, 12 have substantially the same melting temperature, a relatively low temperature, low pressure air stream can be used, resulting in little damage to the fibers in and around the bond area. An example of this can be seen in FIG. 2, with undamaged fibers 84. In contrast, if one of webs 11, 12, or another layer of material intervening between the hot air source and webs 11, 12, is not porous or has a melting temperature which is not substantially the same as the other layers, a relatively high temperature, high pressure air stream may be needed, which may damage the fibers or films in or around the bond area. An example of this can be seen in FIG. 3, with damaged fibers 86.

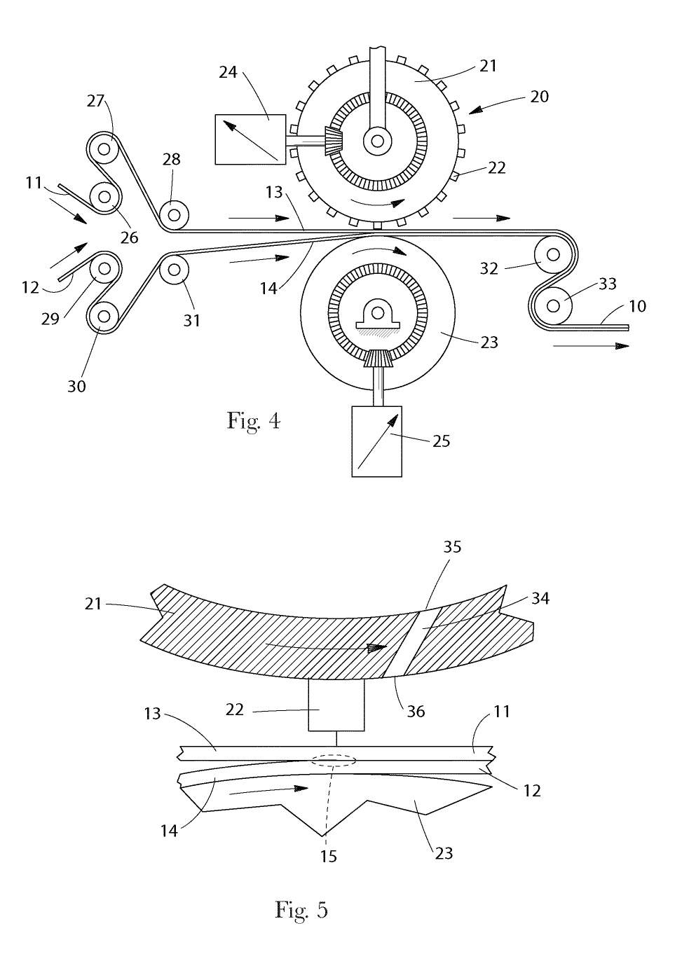

FIG. 4 shows a simplified schematic drawing of an apparatus which may be used for joining webs 11, 12 to form seam 10, similar to the apparatus described in U.S. Pat. No. 6,248,195, which is herein incorporated by reference in its entirety. Apparatus 20 comprises cylinder 21 with projections 22; anvil cylinder 23; means 24, 25 for rotating cylinders 21, 23; and rolls 26 to 33, inclusive, for guiding and advancing webs 11, 12 through and away from the area where energy transfer occurs. It should be noted that there is no need to heat the cylinder 21 and anvil cylinder 23. Apparatus 20 additionally comprises a frame (not shown); a fluid jet nozzle leading to projections 22 (not shown); a temperature control means (not shown) for heating up the fluid; a pressure means (not shown) for regulating the pressure of the fluid; and means (not shown) for driving rolls 26 to 33 for controllably forwarding webs 11, 12 through the area where energy transfer occurs and for enabling the resulting seam 10 to be forwarded to downstream apparatus such as a single pad handling apparatus, which tucks in the fixed sides of the diapers.

For clarity, neither the upstream ends or sources of webs 11, 12, nor the downstream destination or user of the seam 10 are shown. The webs may originate in roll form, and there may be provided upstream unwinding and splicing means to enable forwarding continuous lengths of such webs through joining means and/or converters to make web structures. For simplicity, apparatus 20 is described herein as comprising cylinder 21 and anvil cylinder 23. It is not intended in any way to limit the method described to an apparatus comprising cylinders.

FIG. 5 shows a simplified and partially sectioned view of cylinder 21 with a representative projection 22. Cylinder 21 may comprise, for example, a conical or cylindrical shaped zone 34 through which the fluid required to at least partially melt the meltable components of the webs 11, 12 is directed. For simplicity, the following discussion refers to cylindrical shaped zone 34, as shown in FIG. 5, however, cones, boxes, pyramids, or other shapes could be used for zone 34. A fluid jet nozzle (not shown) is connected to top face 35 of cylindrical shaped zone 34. The fluid may be ambient air or other gases. In addition, use may be made of energetic fields to achieve a partial melting effect. The fluid may be heated up to a temperature ranging from the lower melting point of webs 11, 12 minus 30° C. to the lower melting point of webs 11, 12 plus 100° C. The fluid pressure may range from 0.1×10⁵ Newtons per square meter to 1×10⁶ Newtons per square meter. The diameter at top face 35 of the cylindrical shaped zone 34 ranges from 1 millimeter to 8 millimeters and the diameter of orifice 36 of cylindrical shaped zone 34 may ranges from 0.1 millimeters to 6 millimeters. Cylindrical shaped zone 34 may move with the same or almost same speed as area of overlap 15 of webs 11, 12 for a time interval ranging from 10 to 1000 milliseconds. This enables the heated fluid to be directed toward at least one outer surface 13, 14 to achieve quality seams in terms of strength and softness. Of course, shorter or greater durations may be used where lower strength or softness, respectively, is acceptable. Projections 22 on cylinder 21 may be disposed in a predetermined pattern, with each projection being configured and disposed to precipitate areas of overlap 15 in webs 11, 12 to be joined to effect a predetermined pattern of areas of overlap 15 in the seam 10. Cylinder 21 may have a saw-tooth shape pattern of projections 22 which extend circumferentially about each end of cylinder 21.

Anvil cylinder 23 may be a smooth-surfaced, right circular cylinder of steel, which can be independently power rotated by a speed controlled direct current motor. In an alternative configuration, anvil cylinder 23 may move with the same speed as webs 11, 12 at the area of overlap 15 for a period of time ranging from 20 to 1000 milliseconds. During this time interval, the area of overlap 15 is deformed, joining occurs and cooling follows. There may also be a number of anvils and fluid jet nozzles mounted on a carrier at a pitch ranging between 0.5 and 1.5 times the product pitch.

Means 24, 25 are provided to drive cylinder 21 and anvil cylinder 23. There may be a predetermined but adjustable relationship between the surface velocities of drive cylinder 21 and anvil cylinder 23. This can be synchronous, or asynchronous, that is, with equal surface velocities or with a predetermined surface velocity differential with either cylinder 21 or anvil cylinder 23 being driven faster than the other. Rolls 26 to 33, inclusive, are driven at surface velocities which maintain predetermined levels of tension or stretch so that neither slack web conditions nor excessively tensioned/stretched webs precipitate undesirable consequences. Eight rolls 26 to 33 are shown, however, it should be understood that more or fewer rolls may be used. In some embodiments, no rolls may be needed, as webs 11, 12, and the joined webs may be driven by elements incorporated into drive cylinder 21 and anvil cylinder 23 or by other functional equipment upstream or downstream of apparatus 20.

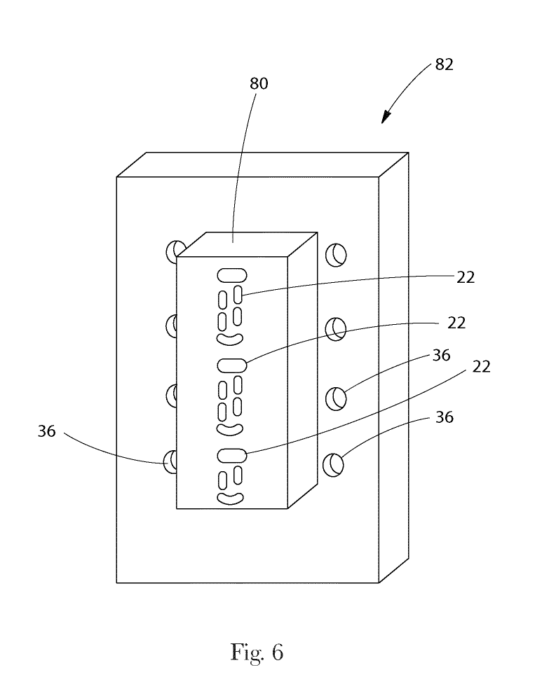

FIG. 6 shows an equivalent stationary process. In contrast to the apparatus of FIG. 4, the apparatus of FIG. 6 does not turn during formation of the seam. The stationary apparatus may be fixed, with webs 11,12 moved to the apparatus, or one or more components may be designed to move some distance with webs 11, 12 as the webs are conveyed along a production line. The exemplary apparatus in FIG. 6 is an integrated assembly 82 having air orifices 36 and compression plate 80. A heat exchanger (not shown) is incorporated in the assembly 82. Compression plate 80 mates with a second plate (not shown), which may also have projections 22, or may be a smooth surface. Of course, separate air orifices and compression plates could be used. The seaming operation may be accomplished in an integrated folding-and-sealing unit, as described, for example, in U.S. Pat. No. 5,779,831 to Schmitz.

The joining of at least two webs 11, 12 that are arranged in an adjacent manner to form a seam 10 as illustrated in FIGS. 1A or 1B may comprise providing a first web 11 and a second web 12, each of the first 11 and second webs 12 being porous and having a melting temperature and an outer surface 13, 14, the melting temperatures of the first 11 and second webs 12 being substantially the same. The method may further comprise placing at least a portion of the first web 11 adjacent at least a portion of the second web 12 to form an overlap area 15. A fluid may be sufficiently heated to enable at least a partial melting of the first and second webs 11, 12. A jet of the heated fluid may be directed toward at least one of the outer surface 13 of the first web 11 and the outer surface 14 of the second web 12. The fluid may be allowed to penetrate the first 11 and second webs 12 such that at least a portion of each of the first 11 and second webs 12 is melted in the overlap area 15. The heated fluid, at a controlled temperature and pressure, may pass from the fluid jet nozzle into cylindrical shaped zone 34 of projection 22 and out through orifice 36, leading to the formation of controlled and concentrated jets of heated fluid, which are directed toward outer surfaces 13, 14 of webs 11, 12 to be joined.

By controlled, it is meant that the temperature and pressure are maintained within a specified range once the nominal set points are selected. For example, a set point may be selected from the ranges discussed above, and the temperature may then be maintained in a fixed range around the nominal set point, such as ±30° C., and the pressure may be maintained in a fixed range around the nominal set point, such as ±1 bar. The acceptable range will depend on the relationship between the properties, such as softening point and/or melting temperature, of the materials to be joined and the nominal set point selected. For example, a nominal set point above the melting temperature of one or more of the materials to be joined may require a tighter control range than a nominal set point well below the melting temperature of one or more material to be joined. The control range may be asymmetrical about the nominal set point. By sufficiently heating, it is meant that the fluid is heated to a temperature that will enable at least partial melting, or at least softening, of the web or webs. Sufficient heating may vary with the materials and equipment used. For example, if the heated fluid is applied to the web or webs almost immediately, with little or no time to cool, the fluid may be heated to approximately the softening point or approximately the melting point of the web or webs. If the heated fluid is directed to the web or webs over some gap in time or distance, such that the heated fluid may cool somewhat before interacting with the web or webs, it may be necessary to heat the fluid above, possibly significantly above, the softening point or melting point of the web or webs.

The fluid may also be delivered to outer surfaces 13, 14 with a pulsed application. The impact of the jet of heated fluid may be adjusted such that both the energy introduced by the jet plus the energy introduced by other means such as the heated anvil (if the anvil is heated), jet nozzle surface, deformation of webs 11, 12, and the internal friction of webs 11, 12 are sufficient to at least partially melt the meltable components in webs 11, 12 to create a certain tackiness, which will form a strong joint at area of overlap 15 upon compression. The melting of the meltable components may occur in a non-uniform manner throughout webs 11, 12.

The short duration of energy transfer in the process described herein may be a dynamic process, and may create a temperature gradient across the meltable components' cross sections. That is, the core of the meltable components may remain solid while the exterior surface of the meltable components melt or come close to melting. Even below the melting temperature, the exterior surface may reach a softening point, such that plastic deformation of the material may occur at a much lower load than for the same material at ambient temperature. Thus, if one or more of the materials to be joined in seam 10 have a softening point, the process may be adjusted to achieve a temperature in at least a portion of webs 11, 12 between the softening point and the melting point. The use of a temperature at or above the softening point but below the melting point of one or more of the meltable components may allow for the creation of a strong bond between webs 11, 12 with reduced disruption to the structure of the meltable components e.g., attenuating or otherwise weakening the meltable components.

The method may further comprise the step of compressing seam 10 with compression tools while the meltable components are at least partially melted, i.e., in the tacky state. This can be achieved by applying pressure to seam 10 using compression tools. The temperature of the compression tools may be at least below the melting point of seam 10. The tackiness property of the meltable components permits the joining of webs 11, 12 and thus, the accumulation of melted web material may be reduced or avoided. Such melted material may form hard, raspy protuberances on the outer surfaces of seam 10 upon solidification. The compression tooling may be designed according to aesthetic criteria, for example, to provide discrete, shaped points where webs 11, 12 are joined. Discrete compression points may also make the seam easier to open. The pattern and spacing of the discrete compression points may be varied. Generally speaking, small differences in the pattern and spacing of the discrete compression points do not change the overall force required to open the seam. However, the distance between discrete compression points may impact the perception of the force required to open the seam. In particular, a large distance between discrete compression points may result in a perception of choppy, discontinuous separation of the seam layers, while a smaller distance between discrete compression points may result in a perception of smooth, continuous separation of the seam layers. The compression points will generally take the shape and spacing of projections 22 on compression plate 80. Projections 22 may be generally oval, as shown in FIG. 6, or may have any other geometric or decorative shape consistent with the desired removal force and removal force perception. Projections 22 may be regularly or irregularly spaced, and may be oriented in various directions, as shown in the exemplary pattern of FIG. 6.

In some embodiments, a method as described herein is part of a method for making an absorbent article. For example, a method for making an absorbent article may comprise providing a first web 11 and a second web 12, each of the first 11 and second webs 12 being porous and having a melting temperature and an outer surface 13, 14, the melting temperatures of the first 11 and second webs 12 being substantially the same. At least a portion of the first web 11 may be placed adjacent at least a portion of the second web 12 to form an overlap area 15. A fluid may be sufficiently heated to enable at least a partial melting of the first and second webs 11, 12. A jet of the heated fluid may be directed toward at least one of the outer surface 13 of the first web 11 and the outer surface 14 of the second web 12. The fluid may be allowed to penetrate the first 11 and second webs 12 such that at least a portion of each of the first 11 and second webs 12 is melted in the overlap area 15. The first web 11 and the second web 12 may comprise a side panel, a front portion, a rear portion, or a combination thereof. The absorbent article may be a pull-on diaper. The pull-on diaper may be intended for infants, children, adults, or household pets. The first and second webs may be nonwoven materials. The first and second webs may further comprise an elastic film. Overlap area 15 may not include the elastic film of the first web, the second web, or both. A method for making an absorbent article may further comprise compressing overlap area 15. The compression of overlap area 15 may be performed simultaneously, or nearly simultaneously, with the partial melting of webs 11 and 12 in the overlap area 15. For example, the compression of overlap area 15 may occur within 5 milliseconds, or 10 milliseconds, or 50 milliseconds of the partial melting of webs 11 and/or 12. An absorbent article formed by this method may have a shear to peel strength ratio of 5:1, or 10:1, or 20:1, or 30:1.

Webs 11, 12 may be non-woven webs with a basis weight ranging from 30 to 500 grams per square meter, containing fibers ranging from microfibers of less than one denier to conventional fibers ranging from 1 to 7 denier. The non-woven webs may also contain scrim materials having strands with diameters greater than 1 millimeter. Based in part on the thickness of the webs, the interval of time required to join the webs 11, 12 with this method may range from 10 to 1000 milliseconds. In some embodiments, 30 to 250 milliseconds may be used for heating and 5 to 250 milliseconds may be used for compression/cooling. In some embodiments, the compression step may be very short, nearly instantaneous. The time intervals used may vary with the nominal pressure and temperature selections. A higher processing time may be tolerated by the materials without damage at lower pressure and/or temperature, whereas higher pressure and/or temperature may be used with shorter processing times.

The use of heated fluid to join at least partially meltable materials has been described. However, little or no distinction was made based on the melting temperatures of the layers in the seam. If one or more layers had a substantially different melting temperature than another layer or layers, the air temperature, or the length of time the materials were exposed to the heated air, or both, were adjusted to accommodate the highest melting temperature in the seam. It has been found that by selecting seam materials for like melting temperatures, it may be possible to increase the ratio of shear load to peel load from approximately 5:1 to 30:1 or higher. Further, a seam between webs of like melting temperature may provide more consistent bonds. As such, when the seam is peeled, the failure mode may be consistent, opening at the bond sites along the length of the seam. The consistent opening mode may provide a neat, clean edge after opening the seam. In contrast, if “the seam” is opened not by disrupting the seam, but by tearing through or delaminating the web material adjacent the seam, an irregular edge may be present.

Using webs of like melting temperature may also provide processing benefits. When the process parameters are adjusted for a relatively high melting temperature, webs in the seam having a lower melting temperature may be damaged during processing. To limit this damage, a relatively small orifice may be used to confine the flow of hot air to a limited area. Using more moderate temperatures and dwell times, relative to the melting temperatures of the webs in the seam, it may be possible to use a larger orifice. A larger orifice may be less prone to tool contamination, and therefore require less frequent or less intense cleaning and maintenance. Further, it may be possible to reduce the dwell times that the seam materials are exposed to hot air, resulting in faster processing.

Still further, using a larger orifice (and associated lower air pressure) may enable use of this process to selectively bond independent layers of a laminate. For example, it may be possible to bond two nonwoven layers without bonding a subjacent film, even if the film has a lower melting temperature than the nonwoven layers that are bonded. Without wishing to be bound by theory, the lower air pressure may limit the influence of the heated air on subjacent layers. Of course, more layers can be added to the bond by modifying the process parameters, e.g., by increasing air temperature, air pressure, and/or air cycle time, or the material characteristics, e.g., basis weight, porosity, softening temperature or melting temperature. Selective bonding of layers is discussed in greater detail below, with reference to the following description of an exemplary absorbent article.

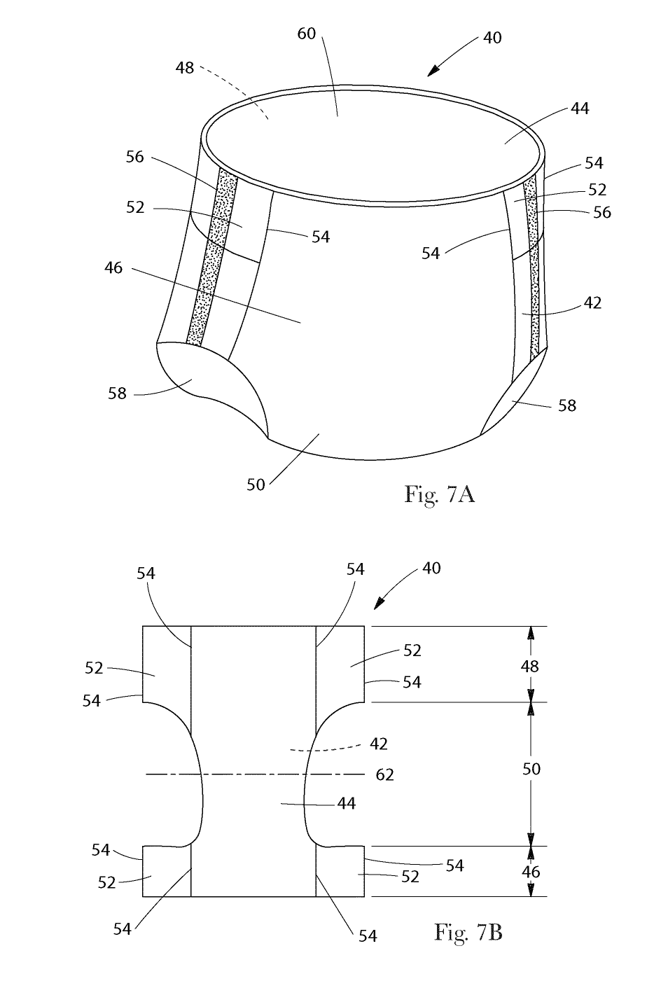

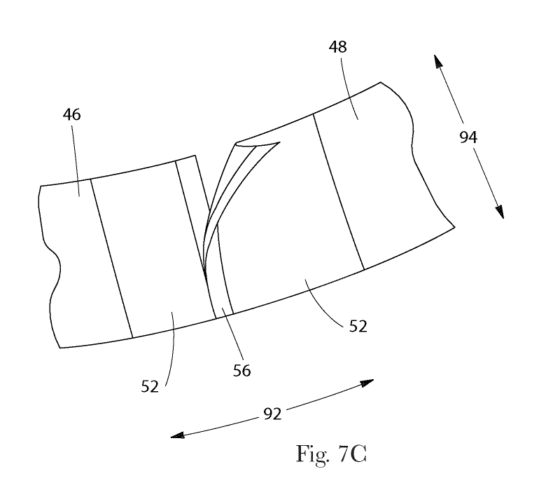

The method described above may be used in the manufacture of disposable absorbent articles. In particular, the method may be used to make side seams for disposable pull-on diapers or pull-on undergarments, including incontinence articles and feminine hygiene products. Exemplary absorbent article 40, as shown in FIGS. 7A and 7B, may have an outer surface 42, an inner surface 44, a front portion 46, a rear portion 48, a crotch portion 50, each of said front portion and said rear portion having side panels 52 with side edges 54 and side seams 56 which join together the side panels of the front portion and the rear portion to form leg openings 58 and a waist opening 60. Absorbent article 40 may comprise a chassis layer; an elastically extensible stretch laminate positioned in each side panel of the front portion, front stretch laminates; an elastically extensible stretch laminate positioned in each side panel of the rear portion, rear stretch laminates; and at least one elasticized waistband positioned in the front portion, the rear portion, or both the front portion and the rear portion. Absorbent article 40 comprises leg openings 58, which may additionally comprise elastic leg features to improve fit at the legs in crotch portion 50.

Absorbent article 40 may have crotch portion 50 comprising a main panel and a pair of leg flap panels. An absorbent core may be positioned within the main panel of the crotch portion, since bodily exudates may be discharged in this area. Outer surface 42 of absorbent article 40 comprises that portion which is positioned away from the body of the wearer, near the wearer's clothing (if present), when fitted to the wearer as intended during use Inner surface 44 of absorbent article 40 is opposed to outer surface 42 and comprises that portion of absorbent article 40 which is positioned adjacent to the body of the wearer, when fitted to the wearer as intended during use.

Elastically extensible stretch laminates (front stretch laminates and rear stretch laminates) may be formed in each side panel 52 of front portion 46, rear portion 48, or both front portion 46 and rear portion 48. Each stretch laminate may be mechanically stretched or drawn to allow the stretch laminate to be elastically extensible in at least the lateral direction. The lateral direction (x direction or width) is defined as the direction parallel to the lateral centerline 62 of absorbent article 40; In contrast, the longitudinal direction (y direction or length) is the direction perpendicular to the lateral centerline 62 of absorbent article 40. Side panels 52 may be an extension of other elements such as the topsheet, the backsheet, or other elements, or side panels 52 may be discrete webs that are joined to other elements, such as the topsheet or backsheet or both. In side seams 56, the stretch laminate may be activated by mechanical stretching to provide additional extensibility in this region. Side seams 56 may also not be activated by mechanical stretching.

In order to provide absorbency and fit to contain bodily discharges, absorbent article 40 may comprise any of a variety of structures known in the art, including, but not limited to, a topsheet, an absorbent core, a backsheet, a fluid acquisition layer, barrier layers or barrier cuffs, leg elastics, gasketing cuffs, anchoring bands, fastening systems, odor control systems, toilet training aids, and the like. Some suitable structures and materials are disclosed, for example, in U.S. Pat. No. 3,860,003; U.S. Pat. No. 4,909,803; U.S. Pat. No. 4,695,278; U.S. Pat. Nos. 4,795,454; 5,360,420; U.S. Pat. No. 4,610,478; U.S. Pat. No. 7,074,215; U.S. Pat. No. 7,179,951; U.S. Pat. No. 7,381,202; U.S. Pat. No. 7,666,175; and U.S. Pat. No. 7,699,825.

Seams for disposable pull-on diapers may be formed by joining the side panels of the front portion to the side panels of the rear portion. In some embodiments, a disposable pull-on diaper comprises a side panel 52 of front portion 46 and a side panel 52 of rear portion 48. Side panels 52 may be joined to form overlapping or butt-type side seams, i.e., a seam 10, according to the method described above. In some embodiments, a single, unitary side panel may be used which is seamed to the front portion 46 and rear portion 48, or which is continuous with front portion 46 or rear portion 48 and seamed to the opposing portion. Of course, a seam and method for making a seam described herein may be used in any application where a relatively high shear load and relatively low peel load are desirable. For example, a seam and method for making a seam described herein may be useful in forming a low peel load seam for holding an absorbent article in a closed position for individual unit sale, as described in U.S. patent application Ser. No. 12/624,822, filed Nov. 24, 2009, titled “Absorbent Articles and Method for Manufacturing Same”. In different applications, the process for making the seam may be varied to produce seams requiring more or less force to open the seam, as desired.

The shear strength may correspond to the strength of the seam to forces applied in the plane defined by lines 92, 94. In the context of an absorbent article, this would generally correspond with the forces applied along the circumference of the wearer's waist, such as forces generated by movement, including the movement of the torso during sedentary activities like breathing and the movement of the torso during more robust activity, such as rolling, crawling, sitting up, walking, and the like. The peel strength may correspond to the strength of the seam to forces applied perpendicular to the plane defined by lines 92, 94. In the context of an absorbent article, this would generally correspond with the forces applied to intentionally peel apart the layers in seam 15, as when removing the absorbent article from the wearer, or disrupting the seam to check for soiling or to adjust the fit of the absorbent article. It should be understood that the directional strength of the seam is not dependent on the orientation in which it is formed, and an article produced in an alternate orientation would be expected to have similar properties to one formed in the indicated orientation. That is, shear strength should be strong whether the shear force is applied in a direction along line 92 or along line 94 within the plane defined by lines 92, 94.

Providing a seam that is difficult to disrupt in one direction and easy to disrupt in another direction allows an article, such as a disposable diaper, to be configured to be strong during use and yet easy to remove. For example, as discussed above, a seam as described herein may be used to join the side panels of an absorbent article, to form, for example, a pull-on diaper. The seam joining the side panels should be strong relative to shear loads. Otherwise, the side panels might be unintentionally and/or undesirably disrupted during normal activity, resulting in a loose diaper or a diaper that falls off. It may also be desirable for the seam joining the side panels to be easy to disrupt with a peel load, so that the diaper can be removed without dragging a soiled diaper down the entire length of the wearer's legs. Because normal activities, such as breathing, sitting, and walking, do not generally produce high peel loads, a lower peel load may facilitate removal of an absorbent article without significantly increasing the risk of unintentional and/or undesirable seam failure during use.

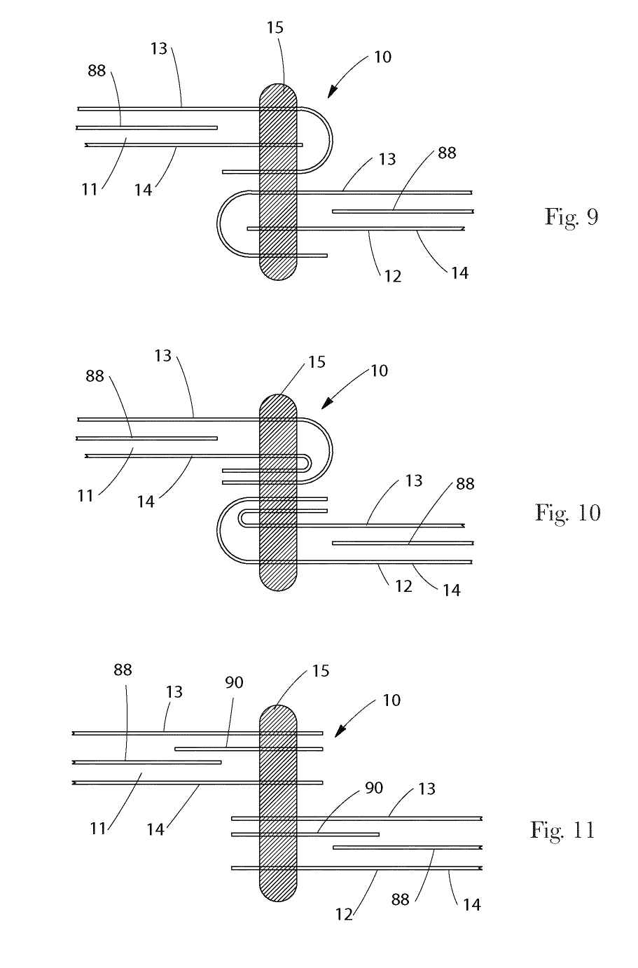

In some embodiments, the side panel or side panels may comprise an elastic film. The elastic film may provide an elastic return force to the side panel or side panels, such that the side panels help to hold the absorbent article against the body of the wearer for a range of wearer sizes and shapes. In some embodiments, the elastic film does not extend to the edges of the side panel or side panels to be included in seam 15. For example, the elastic film may be a layer like layer 88 in FIG. 10, which is part of the side panel or side panels, but is not part of the seam. In this way, an elastic film which does not have a melting temperature substantially the same as the melting temperatures of the other layers in a side panel laminate can be employed with a seam as described herein. Alternately, the side panel may include only layers having substantially the same melting temperature, with or without an elastic component.

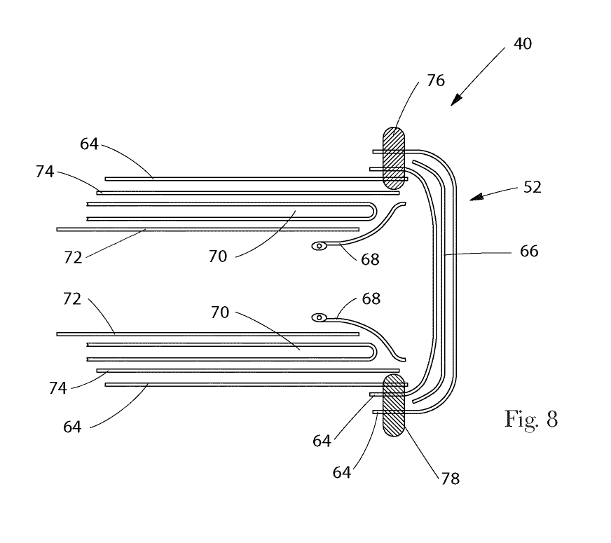

As discussed above, by controlling process factors, such as fluid temperature, fluid pressure, fluid nozzle geometry, the distance between the fluid nozzle and the material, and fluid cycle time, it may be possible to join only selected layers of a multi-layer composite. For example, as shown in FIG. 8, it may be possible to join only the ear materials at the side of an absorbent article, without also capturing adjacent portions of the absorbent core 70 and/or leg cuff 68 materials. This may be useful because it may be undesirable to join all of these layers together, and may be difficult or impossible to join only selected layers in any other manner once the layers are placed adjacent to one another. For example, a leg cuff 68 may be intended to “stand up” away from underlying structures to provide a barrier to liquid leakage at the leg of the wearer. If the leg cuff were pinned to lower layers, it might not be able to “stand up,” and the barrier function might be compromised. Traditional heated nip joints cannot selectively join only some layers of a laminate. Similarly, when joining porous, relatively low basis weight materials, glues and other adhesives may permeate the materials and join other layers, intentionally or unintentionally.

Using the process described herein, it may be possible to form different seams at front side seam 76 and rear side seam 78. As shown in FIG. 8, rear side seam 78 may encompass two layers of nonwoven materials 64 associated with side panel 52, a nonwoven layer 64 of the backsheet, a polymer film layer 74 of the backsheet, and part of the leg cuff 68. Front side seam 76 may include only nonwoven materials 64 associated with side panel 52 and the backsheet. That is, front side seam 76 may not penetrate through polymer film layer 74. Thus, in this exemplary embodiment, front side seam 76 provides an easy-open bond at the front of absorbent article 40, and rear side seam 78 provides a high-strength bond that bonds layers from multiple substructures in absorbent article 40. In such an embodiment, rear side seam 78 may be formed using any joining technique, including the method described herein.

A seam can be reinforced using additional material without capturing subjacent layers using the exemplary structures shown in FIGS. 9-11, showing layer 88 which is proximate seam 10, but not part of seam 10. For example, in FIG. 9, one web 11 has been wrapped around another web 12, providing a 6-layer structure which may provide additional bulk and strength at the seam relative to the non-wrapped structure shown in FIG. 1A. FIG. 10 shows each of two webs, 11, 12, folded over prior to seaming, creating an 8-layer structure. It is also possible to provide a dedicated reinforcement material 90, as shown in FIG. 11. The use of dedicated reinforcement material 90 may help form a stronger seam without adding as much bulk as the 8-layer structure shown in FIG. 10. To preserve the easy-open benefit of the seam, the dedicated reinforcement material of FIG. 11 may be porous and may have substantially the same melting temperature as the other materials in the seam. Of course, it is also possible to reinforce the seam by including additional, adjacent layers that have functions other than reinforcing the seams, e.g., to extend and include layer 88 in the seam. It may be desirable to use alternate reinforcing structures where, for example, layer 88 is not porous, or has a melting temperature substantially different from the melting temperatures of web 11 or web 12.

Other examples where a seam as described herein may be useful include disposable or lightweight garments, such as hospital gowns, coveralls, aprons, bibs, and the like. Although the seam as described above is not necessarily refastenable, the seam may be used in conjunction with a refastenable fastening system, such as mechanical fasteners, adhesive fasteners, cohesive fasteners, and the like, such that the webs can be rejoined after the seam is disrupted. This may be useful, for example, when checking to see whether a pull-on diaper is soiled, or for adjusting the fit of a disposable article, including disposable garments.

### EXAMPLES

The following table shows the effects of conforming the web materials in a hot-air seam to materials of like melting temperature.

| Peak Load | | | | |
|---|---|---|---|---|
| Average and | | | | |
| (Standard Deviation) | | | | |
| in Newtons | Example 1 | Example 2 | Example 3 | Example 4 |
| Materials in Seam | NW1* | NW1 | NW1 | NW1 |
| (Melting | (160-165° C.) | (160-165° C.) | (160-165° C.) | (160-165° C.) |
| Temperature in ° C.) | Film** (230° C.) | NW1 | NW1 | NW1 |
| | NW1 | (160-165° C.) | (160-165° C.) | (160-165° C.) |
| | (160-165° C.) | | | |
| Process Parameters | 200° C., 4 bar, | 180° C., 1.5 bar, | 170° C., 1.5 bar, | 160° C., 1.5 bar, |
| and Seaming Tool | 200 msec air | 140 msec air | 140 msec air | 140 msec air |
| | blow | blow | blow | blow |
| | Round | Round | Round | Round |
| | compression | compression | compression | compression |
| | tool with 0.5 mm | tool with 1 mm | tool with 1 mm | tool with 1 mm |
| | orifice | orifice | orifice | orifice |
| CD Shear Load⁺ | 39 (4) | 81 (5) | 78 (10) | 66 (5) |
| (Std. Dev.) | | | | |
| CD Peel Load⁺⁺ | 20 (3) | 48 (5) | 43 (4) | 18 (3) |
| (Std. Dev.) | | | | |
| MD Peel Load⁺⁺⁺ | 8.7 (1.1) | 15.7 (2.2) | 9.7 (1.1) | 1.7 (0.3) |
| (Std. Dev.) | | | | |

*NW1 is a 27 gsm, carded nonwoven fabricated by BBA under the tradename HEC.
**Film is a block copolymer (thermoplastic elastomer).
⁺Corresponding to overlap seam in wear/during use.
⁺⁺Corresponding to butt seam in wear/during use.
⁺⁺⁺Corresponding to removal/seam tearing.

Example 1 represents a seam comprising webs having substantially different melting temperatures. Examples 2-4 represent a hot air seaming process for webs having substantially the same melting temperatures, at different process temperatures. As can be seen from the table, eliminating the high melting temperature web from the seam allows for the formation of seams of greater CD shear force at lower temperatures, pressures, and processing times. Lower temperatures may also generate higher ratios of CD shear to MD peel loads and/or lower variation between samples. Seams according to Examples 2-4 do not appear over-bonded or rough. The sample size for each example is 10. Measurements are taken using an Instron machine. In this Example, the Cross-Direction (CD) corresponds to line 92 in FIG. 7C, and the Machine-Direction (MD) corresponds to line 94 in FIG. 7C.

### Test Method for Air Permeability

A Testex FX 3300 instrument (or equivalent) is used to measure air permeability according to Method 5450 of Federal Test Method Standard No. 191A, using a sample area of 38 cm² and a pressure drop across the sample of 125 Pa. The specimen size used may not always be 7 inches by 7 inches (approximately 17.8 cm by 17.8 cm), however, the specimen size is always sufficient for the 38 cm² circular area so as not to affect the test results in any way. A sample testing below the lower limit of the instrument range, listed in the manual for the Testex FX 3300 instrument as 0.05 cm³/cm²/sec, is considered impermeable to air for the purposes of this disclosure.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of joining two or more webs, the method comprising:
providing a first web and a second web, each of the first and second webs being porous and having a melting temperature and an outer surface, the melting temperatures of first and second webs being substantially the same;
placing at least a portion of the first web adjacent at least a portion of the second web to form an overlap area;
sufficiently heating a fluid to enable at least a partial melting of the first and second webs;
directing a jet of the heated fluid toward at least one of the outer surface of the first web and the outer surface of the second web; and
allowing the heated fluid to penetrate the first and second webs such that at least a portion of each of the first and second webs is melted in the overlap area.

2. The method of claim 1, wherein the portions of the first and second webs forming the overlap area are joined to form an overlap seam.

3. The method of claim 1, wherein the portions of the first and second webs forming the overlap area are joined to form a butt seam.

4. The method of claim 1, wherein the fluid is ambient air.

5. The method of claim 1, further comprising compressing the first and second webs in at least a portion of the overlap area.

6. The method of claim 1, wherein the first and second webs are non-wovens.

7. The method of claim 1, further comprising bonding a third web to at least one of the first web and the second web at a location inboard of a seam between the first web and the second web.

8. The method of claim 7, wherein the third web has a melting temperature which is not substantially the same as the melting temperatures of the first and second webs.

9. The method of claim 1, wherein the melting temperatures of the first and second webs are the same.

10. The method of claim 1, further comprising providing a fourth web, the fourth web being porous and having a melting temperature and an outer surface, the melting temperature of the fourth web being substantially the same as the melting temperatures of the first and second webs;
placing a portion of the fourth web adjacent a portion of the first web or a portion of the second web in the overlap area;
sufficiently heating a fluid to enable at least a partial melting of the first, second, and fourth webs; and
allowing the heated fluid to penetrate the first, second, and fourth webs such that at least a portion of each of the first, second, and fourth webs is melted in the overlap area.

11. The method of claim 10, wherein the fourth web overlaps the first web or the second web.

12. The method of claim 11, wherein the fourth web overlaps the first web and the second web.

13. A seam produced according to the method of claim 1.

14. An absorbent article comprising the seam of claim 13.

15. The absorbent article of claim 14, wherein the ratio of shear load to peel load is greater than about 8:1.

16. The absorbent article of claim 15, wherein the ratio of shear load to peel load is greater than about 30:1.

17. A method of selectively seaming only selected layers of a laminate, comprising:
providing a first web and a second web, each of the first and second webs being porous and having a melting temperature and an outer surface, the melting temperatures of first and second webs being substantially the same;
providing a fifth web;
placing one edge of the first web adjacent one edge of the second web;
placing one edge of the second web adjacent one edge of the fifth web, such that the fifth web is not adjacent to the first web;
sufficiently heating a fluid to enable at least a partial melting of the first and second webs;
directing a jet of the heated fluid toward at least one of the outer surface of the first web and the outer surface of the second web; and
allowing the heated fluid to penetrate only the first and second webs, such that at least a portion of each of the first and second webs is melted.

18. The method of claim 17, further comprising compressing the first and second webs in at least a portion of the overlap area.

19. The method of claim 18, further comprising compressing the first, second, and fifth webs in at least a portion of the overlap area.

20. The method of claim 19, further comprising providing a reinforcement material, placing a portion of the reinforcement material adjacent the first web or the second web, and allowing the heated fluid to penetrate the reinforcement material.
